(19) United States
(12) Patent Application Publication
(10) Pub. No.: US 2023/0349746 A1
(43) Pub. Date: Nov. 2, 2023

(54) ANTENNA FOR RADAR-BASED FILL LEVEL MEASURING DEVICES

(71) Applicant: Endress+Hauser SE+Co. KG, Maulburg (DE)

(72) Inventors: Pablo Ottersbach, Essen (DE); Winfried Mayer, Buch (DE)

(21) Appl. No.: 18/006,462

(22) PCT Filed: Jun. 21, 2021
(86) PCT No.: PCT/EP2021/066755

§ 371 Date: Jan. 23, 2023

(30) Foreign Application Priority Data
Jul. 23, 2020 (DE) 10 2020 119 435.8

(51) Int. Cl. G01F 23/284

(52) U.S. Cl. CPC G01F 23/284

(57) ABSTRACT

A compact and efficient antenna for radiofrequency radar-based fill level measuring devices includes a mount with a media-tight cavity; an input coupling structure by means of which the radar signal is able to be coupled into the cavity along a main beam axis; and a lens that refracts the radar signal. The lens seals the cavity of the mount in such that the input coupling structure is located in the focus of the lens and the lens is aligned in the main beam axis of the input coupling structure. The mount or the lens and the input coupling structure may be constructed from two separate sub-components assembled along a defined joining seam such that the cavity is sealed in media-tight fashion and the mount or the antenna is formed.

The invention relates to an antenna for radar-based fill level measurement and to a production method for producing such an antenna.

In process automation technology, field devices for capturing or modifying process variables are generally used. For this purpose, the functioning of the field devices is in each case based on suitable measuring principles in order to capture the corresponding process variables, such as fill level, flow rate, pressure, temperature, pH value, redox potential or conductivity. A wide variety of such field devices is manufactured and distributed by the Endress+Hauser company.

For measuring the fill-level of filling materials in containers, radar-based measuring methods have become established, since they are sound and low-maintenance. Thereby, the pulse transit time principle and the FMCW (“frequency modulated continuous wave”) principle are predominantly implemented. These measurement principles are described in greater detail, for example, in “Radar Level Detection, Peter Devine, 2000.” A key advantage of radar-based measuring methods lies in the ability to measure the fill-level more or less continuously. In the context of this patent application, the term “radar” refers to radar signals having frequencies between 0.03 GHz and 300 GHz. Typical frequency bands with which fill level measurement is performed are 2 GHz, 6 GHz, 26 GHz or 79 GHz. The higher the frequency band that is selected, the narrower the beam cone of the radiated radar signal is with otherwise identical antenna dimensions.

Irrespective of the implemented measurement principle, the transmitting and receiving units of the fill level measuring device can be implemented for radar frequencies starting at approximately 20 GHz and higher than a common integrated circuit. In principle, fill level measuring devices with higher radar frequencies can therefore be produced more compactly and with better installation characteristics. It is true that the dimensioning of the antenna to be used can also be reduced with increasing frequency without undesirably increasing the beam cone. Nevertheless, compared to the further components of the fill level measuring device, the antenna still has comparatively large dimensions. Furthermore, the beam cone is increased or side lobes are formed when the antenna is reduced in size. Moreover, the media-tight manufacturability of the antenna is more difficult when dimensions are reduced, because undercuts and cavities of small dimensions can hardly be produced.

The invention is therefore based on the object of providing an efficient and easily producible antenna for radar-based fill level measuring technology with which the corresponding fill level measuring device can be designed to be extremely compact.

The invention achieves this objective by an antenna for radar-based fill level measuring devices, which comprises the following components:
a mount with a medium-tight cavity,
an input coupling structure by means of which a radar signal is able to be coupled into the cavity along a main beam axis, and
a lens that refracts the radar signal and seals the cavity of the mount in such a way that the input coupling structure is located within the focus of the lens and such that the lens is aligned in the main beam axis of the input coupling structure.

The term “media-tight” within the scope of the invention relates to particle and liquid impermeability, and not necessarily also to gas or overpressure tightness.

By means of the lens, the antenna can be made according to the invention extremely compactly and with a narrow beam cone. Accordingly, the lens is preferably convex or semi-convex with respect to the radar signal.

The efficiency of the antenna can be further optimized if the lens has a diameter matched to the input coupling structure in such a way that the lens completely covers the main emission lobe, in which lobe the input coupling structure transmits the radar signal along the main beam axis. In the context of the present patent application, the term “main emission lobe” means the region, which is enclosed by those spatial angles at which, starting from the main emission axis (i.e., the vector of the maximum power of the emitted radar signal), the power has decreased to 50% or by −3 dB. Furthermore, the antenna according to the invention can be optimized with respect to its efficiency if the lens, the cavity and/or a surface of the lens facing the cavity have an anti-reflection layer for the radar signal, such as, in particular, an in some cases chemically based surface texture. The cavity can also have a metallic coating at least in a partial region. Depending on this, the dimensions of the antenna may in some cases be further reduced.

Due to the compact design of the antenna according to the invention, it is particularly expedient to use the antenna in radar-based fill level measuring devices, the transmitting/receiving unit of which is designed to generate the underlying electrical high-frequency signal with a high frequency of at least 60 GHz, in particular more than 100 GHz, because at such high frequencies the fill level measuring device can, in general, already be designed very compactly. A corresponding fill level measuring device for measuring a fill level of a filling material located in a container comprises at least the following components:
an antenna according to any of the previously described embodiment variants, wherein the antenna or the measuring device is to be arranged in such a way that the main emission axis of the antenna is oriented approximately vertically in order to transmit the radar signal toward the filling material, and to receive the reception signal reflected accordingly by the filling material, and
a transmitting/receiving unit, which is designed,
   for generating the radar signal to couple an electrical high-frequency signal into the input coupling structure of the antenna,
   to decouple the reception signal via the input coupling structure, and
   to determine the fill level at least on the basis of the decoupled reception signal.

It is not relevant within the scope of the invention whether the transmitting/receiving unit is designed to generate the high-frequency signal according to the FMCW method or to determine the fill level according to the FMCW method, or whether the pulse transit time principle is implemented.

With reference to the fill level measuring device, the term “unit” within the scope of the invention is understood in principle to mean all electronic circuits that are suitably designed for the proposed purpose. It can therefore be an analog circuit for generating or processing corresponding analog signals. However, it can also be a digital circuit, such as an FPGA, or a storage medium in interaction with a program. Thereby, the program is designed to perform the corresponding method steps or to apply the necessary calculation operations of the respective unit. In this context, various electronic units of the measuring device in the sense of the invention can potentially also access a common physical memory or be operated by means of the same physical digital circuit.

An advantage of the antenna according to the invention is also the potentially low-cost manufacturability. In particular, the medium-tight cavity can be realized without elaborate manufacturing steps when the mount is produced on the basis of at least two sub-components. For this purpose, the sub-components are to be designed such that, in each case, one of the sub-components comprises the lens and/or the input coupling structure in addition to the pure mount shape, and that the sub-components in each case comprise a corresponding joint seam along the cavity. The corresponding method for manufacturing the antenna provides in this case the following method steps:
manufacturing the first sub-component of the mount,
manufacturing the second sub-component of the mount, and
subsequently joining the two sub-components together along the joining seam by means of welding or gluing, for example, so that the cavity is sealed media-tight and the mount is formed.

This method makes it possible for all components of the antenna, i.e., the mount, the input coupling structure and the lens to be made of an identical material, in particular a plastics material. For this purpose, the first sub-component and the second sub-component are accordingly made of the same material, for example by means of injection molding or hot stamping. In particular, PEEK, PFA or PTFE can be used as the plastics material for manufacturing the two sub-components, because these materials have a suitable dielectric value of greater than 2, in particular greater than 4, with regard to the radar refraction properties.

The invention is explained in more detail with reference to the following figures. The following are shown:

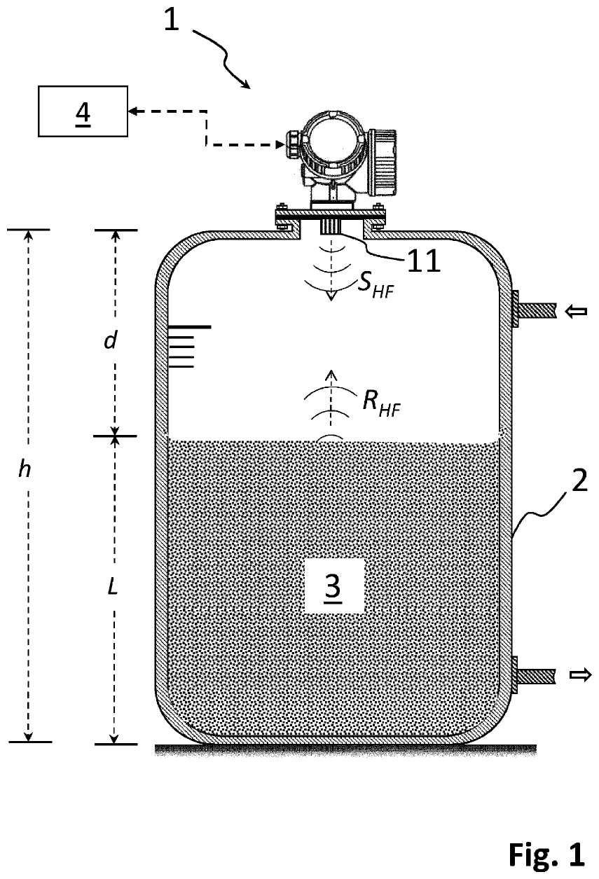

FIG. 1: a typical arrangement of a radar-based fill-level measuring device on a container, and

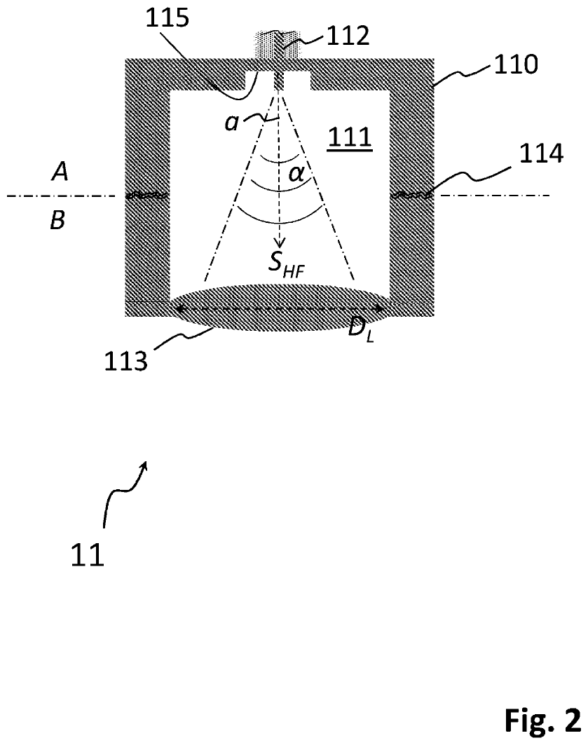

FIG. 2 an antenna according to the invention for radar-based fill level measuring devices.

For a basic understanding of the invention, FIG. 1 shows a typical arrangement of a freely radiating, radar-based fill level measurement device 1 on a container 2. A filling material 3, whose fill level L is to be determined by the fill level measuring device 1, is located in the container 2. For this purpose, the fill level measuring device 1 is mounted on the container 2 above the maximum permissible fill level L. Depending on the field of application, the installation height h of the fill level measurement device 1 above the container bottom can be up to more than 100 m.

As a rule, the fill level measuring device 1 can be connected via an interface, which is based on a corresponding bus system such as “Ethernet,” “PROFIBUS,” “HART” or “Wireless HART,” to a superordinate unit 4, for example a process control system, a decentralized database or a handheld device such as a mobile radio device. On the one hand, information about the operating status of the fill level measuring device 1 can thus be communicated. However, further information relating to the fill level L can also be transmitted via the interface.

Since the fill level measuring device 1 shown in FIG. 1 is designed as a freely radiating radar, it comprises a corresponding antenna 11. The antenna 11 or the fill level measuring device 1 as shown in FIG. 1 is oriented such that corresponding radar signals S_{HF} are emitted in the direction of the filling material 3. The respective radar signal S_{HF} is generated in a transmitting/receiving unit of the fill level measuring device 1 depending on the measurement principle (pulse transit time or FMCW) and supplied to the antenna 11.

The transmitted radar signal S_{HF} is reflected by the surface of the filling material 3 and received as a reception signal R_{HF} by the antenna 11 or the downstream transmitting/receiving unit of the fill level measuring device 1 after a corresponding signal transit time. Since the signal transit time of the radar signals S_{HF}, E_{HF} has a linear dependence on the distance d=h−L of the fill level measuring device 1 from the filling material surface, the transmitting/receiving unit can determine the fill level L on the basis of the reception signal R_{HF} according to the respectively implemented measuring principle.

The fill level measuring device 1 explained in reference to FIG. 1 operates in a modern design at a radar frequency of 20 GHz or even significantly more, up to 160 GHz. The antenna 11 can be dimensioned accordingly small without the beam cone thereof becoming too large and thus, for example, interference reflections being generated on the side wall of the container 2.

In terms of manufacturing technology, however, a correspondingly compact antenna 11 can be produced only with difficulty, because it has to be manufactured with chip-removing and thus cost-intensive methods, such as turning, for example, because, for example, the injection molding process can lead to cavities and depressions in or on the antenna 11. Furthermore, a filled dielectric antenna 11, in which the focal length space is filled with a plastics material, generally has a significantly poorer efficiency than classical lens antennas, in which air or vacuum prevails in the focal length space.

An antenna 11 according to the invention, which from this perspective, can be compactly designed and easily manufactured, is shown in more detail as a cross-sectional view in FIG. 2: The core of the antenna 11 is a mount 110. Thereby, the mount 110 forms a cavity 111 that functions as a focal length space. As can be seen in FIG. 2, the cavity 111 is closed off by a convex lens 113 at that end region of the mount 110, which is oriented in the mounted state of the fill level measuring device 1 toward the filling material 3. Opposite the lens 113, a dielectric input coupling structure 112 is admitted into the mount 110 at the cavity 111, wherein the main emission axis a of the input coupling structure 112 is directed into the cavity 111. The input coupling structure 112 serves to decouple the radar signal S_{HF} to be emitted of the transmitting/receiving unit of the fill level measuring device 1 via the cavity 111 toward the filling material 3.

For corresponding contacting with the transmitting/receiving unit, the input coupling structure 112 outside the mount 110 can be further guided, for example, as a dielectric waveguide that can optionally be adapted in its length (not explicitly shown in FIG. 2). In the embodiment shown in FIG. 2, the mount 110 additionally comprises a groove 115 on the cavity side around the rod-shaped input coupling structure 112, as a result of which an undesired coupling of the radar signal S_{HF} into the mount 110 is suppressed.

For decoupling the radar signal S_{HF} from the cavity 111 toward the filling material 3, the mount 110 is designed in such a way that the rod-shaped end of the input coupling structure 112 is located within the focus of the lens 113, wherein the lens 113 is aligned in the main beam axis a of the input coupling structure 112. As a result, the radar signal S_{HF} is bundled correspondingly when it exits from the antenna 11 toward the filling material 3. By virtue of the resulting narrow transmission cone of the antenna 11, said antenna can therefore be produced according to the invention with very compact dimensions. The reciprocal properties for antennas likewise apply to the reception signal R_{HF} to be coupled in.

As is indicated in FIG. 2, the efficiency of the antenna 11 is further increased when the lens 113 is matched to the input coupling structure 112 with respect to its diameter DL in that the lens 113 is wider than the main emission lobe a of the input coupling structure 112. In contrast to the embodiment of the antenna 11 shown in FIG. 2, it is also possible in this regard to design the cavity 111 to be not cylindrical or cuboid, but instead conically in such a way that the cavity 111 widens correspondingly from the input coupling structure 112 toward the lens 113. It goes without saying that the antenna 11 with regard to its dimensioning is to be matched to the respectively used frequency of the radar signal S_{HF}, R_{HF}. For the sake of clarity, any fastening means on the mount 110 for fixing the antenna 11 to the fill level measuring device 1 or to the container 2 are not shown in FIG. 2.

The method shown in FIG. 2 antenna 11 based on two separately manufactured sub-components A, B, which, by subsequent joining together, form the antenna 11 together with the mount 110 or the lens 113 and the input coupling structure 112. The sub-components A, B are first individually manufactured by means of injection molding or hot stamping such that the sub-components A, B have a common joint seam 114 for joining purposes. In the embodiment of the sub-components A, B shown in FIG. 2, the joint seam 114 runs centrally through the cavity 110, so that the first sub-component A comprises the input coupling structure 112, while the second sub-component B comprises the lens 113. In principle, however, it is not relevant within the scope of the invention where exactly the joint seam 114 extends between the sub-components A, B. After the injection molding of the sub-components A, B and before the joining, the sub-components A, B in the region of the later cavity 111 can optionally also be surface-treated, for example by a metallic coating or a surface texture on the lens 113, so that the beam characteristic of the antenna 11 is optimized.

The joining technique of sub-components A, B to be used is to be selected, inter alia, depending on the material from which the sub-components A, B are manufactured. Depending on the material, welding or gluing, for example, can be used for the joining. Thereby, it is essential that the resulting cavity 111 is sealed media-tight, i.e., particle- and moisture-impermeable during the joining. As a result, the cavity 111 is protected against unwanted dirt accumulation, so that the beam properties of the antenna 11 are not impaired by the measurement operation. Depending on the atmosphere under which the sub-components A, B are joined, the cavity 111 can also be subjected to a vacuum or an inert gas in order to further improve the beam characteristic of the antenna 11.

It is also advantageous in connection with the joining of the sub-components A, B if both sub-components A, B are made of an identical material, such as PEEK or PTFE, so that the resulting mount 110, the lens 113 and the input coupling structure 112 each consist of the same material. With regard to the material selection, it must be taken into account here that the material for beam refraction in the lens 113 and for beam guidance in the input coupling structure 112 has a suitable dielectric value of, for example, at least 2, optimally greater than 4. An advantage of manufacturing the antenna 11 on the basis of two sub-components A, B is that the cavity 111 and any later undercuts may be realized without excessive material outlay, without elaborate process steps and thus cost-effectively.

### LIST OF REFERENCE SIGNS

1 Fill level measuring device
2 Container
3 Filling material
4 Superordinate unit
11 Antenna
110 Mount
111 Cavity
112 Input coupling structure
113 Lens
114 Joining seam
115 Groove
A, B Sub-components
a Beam axis
d Measuring distance
h Installation height or measurement range
L Fill level
R_{HF} Reception signal
S_{HF} Radar signal
a Main emission lobe

1-14. (canceled)

15. An antenna for a radar-based fill level measuring device, comprising:
a mount having a media-tight cavity;
an input coupling structure via which a radar signal may be coupled into the cavity along a main beam axis; and
a lens configured to refract the radar signal and to seal the cavity of the mount such that the input coupling structure is located within the focus of the lens and that the lens is aligned in the main beam axis of the input coupling structure.

16. The antenna according to claim 15, wherein the mount, the input coupling structure, and the lens are embodied of a same material.

17. The antenna according to claim 15, wherein the lens has a diameter matched to the input coupling structure such that the lens completely covers a main emission lobe in which the input coupling structure transmits the radar signal along the main beam axis.

18. The antenna according to claim 15, wherein the lens, the cavity, and/or a surface of the lens facing the cavity includes an anti-reflection layer for the radar signal.

19. The antenna according to claim 15, wherein the lens is convex or semi-convex.

20. The antenna according to claim 15, wherein the cavity has a metallic coating at least in a partial region.

21. A radar-based fill level measuring device for measuring a fill level of a filling material located in a container, the fill level measuring device comprising:
an antenna, including:
a mount having a media-tight cavity;
an input coupling structure via which a radar signal may be coupled into the cavity along a main beam axis; and
a lens configured to refract the radar signal and to seal the cavity of the mount such that the input coupling structure is located within the focus of the lens and that the lens is aligned in the main beam axis of the input coupling structure,
wherein the antenna can be arranged such that the main emission axis is oriented vertically to transmit the radar signal toward the filling material and to receive a reception signal correspondingly reflected by the filling material; and
a transmitting/receiving unit configured to:
generate the radar signal and couple a corresponding high-frequency signal into the input coupling structure;
decouple the reception signal via the input coupling structure; and
determine the fill level at least based on the decoupled reception signal.

22. The fill level measuring device according to claim 21, wherein the transmitting/receiving unit is designed to generate the high-frequency electrical signal with a frequency of at least 60 GHz.

23. The fill level measuring device according to claim 21, wherein the transmitting/receiving unit is configured to generate the high frequency signal according to the FMCW method and to determine the fill level according to the FMCW method.

24. A method for manufacturing an antenna for a radar-based fill level measuring device, wherein the antenna includes:
a mount having a media-tight cavity;
an input coupling structure via which a radar signal may be coupled into the cavity along a main beam axis; and
a lens configured to refract the radar signal and to seal the cavity of the mount such that the input coupling structure is located within the focus of the lens and that the lens is aligned in the main beam axis of the input coupling structure, the method comprising:
manufacturing a first sub-component of the mount,
manufacturing a second sub-component of the mount, wherein the first and second sub-components are designed such that one of the sub-components includes the lens and/or the input coupling structure, and such that the sub-components each have a corresponding joint seam along the cavity; and
joining the two sub-components along the joint seam so that the cavity is sealed media-tight and the mount is formed.

25. The method according to claim 24, wherein the first sub-component and/or the second sub-component are/is manufactured by injection molding.

26. The method according to claim 24, wherein the sub-components are joined by welding or gluing.

27. The method according to claim 24, wherein the first sub-component and the second sub-component are made of an identical material.

28. The method according to claim 27, wherein the first sub-component and the second sub-component are made of a plastics material, PEEK, PFA, or PTFE.

29. The antenna according to claim 18, wherein the anti-reflection layer is a surface texture.
